(19) United States
(12) Patent Application Publication
(10) Pub. No.: US 2004/0064992 A1
(43) Pub. Date: Apr. 8, 2004

(54) Device for display samples, in particular cosmetic products

(76) Inventor: Philippe Borys, Paris (FR)

Correspondence Address: LEYDIG VOIT & MAYER, LTD, 700 THIRTEENTH ST. NW, SUITE 300, WASHINGTON, DC, 20005-3960, US

(21) Appl. No.: 10/470,551

(22) PCT Filed: Jan. 24, 2002
(86) PCT No.: PCT/FR02/00299

(30) Foreign Application Priority Data
Jan. 31, 2001 (FR) 01/01313

(51) Int. Cl. G09F 3/18

(52) U.S. Cl. 40/642.02

(57) ABSTRACT

A device for displaying samples, particularly designed for cosmetic products including a frame having a front edge receiving the samples. The front edge has a polished section having a base bordered by fixed flaps, and the samples are arranged in a rack beneath a removable top forming a lid for the profiled section.

The invention relates to a device for display of samples, in particular cosmetic products, of the type having a frame whose front edge receives these samples.

Although devices of this type are known and have been used for a long time, their optimization continues to be the object of developments.

In this general context, the invention in particular aims to propose a display device with a relatively simple structure and which nevertheless makes possible easy and rapid replacement of the samples.

To this end, the device of the invention, in other respects in accordance with the generic definition given for it by the preamble above, is essentially characterized by the fact that the front edge of the frame is formed by a profiled section elongated according to a first direction and having a bottom bordered by lower and upper folds both projecting, in cross section, from the bottom, by the fact that this device has a removable cap elongated according to the first direction, forming a cover for the profiled section, and having a display surface bordered by lower and upper flaps both projecting, in cross section, from the display surface in the direction of the bottom of the profiled section and respectively overlapping the lower and upper folds, by the fact that the upper flap goes beyond the upper fold sloping towards the bottom in order to form an elementary articulation of the cap on an edge common to the upper fold and to the bottom of the profiled section, and by the fact that the samples are received in a small bar inserted between the bottom of the profiled section and the display surface of the cap, these samples being made accessible, from the exterior of the cap, through openings made in the display surface of this cap.

The display device thus designed can be secured against theft of the samples, in particular consumable samples.

To do this, it is possible to provide that the bottom carry some first locking means, that the lower flap have a border which goes beyond the lower fold, and that the border of the lower flap have some second locking means which cooperates with the first locking means in order to selectively allow or prevent a relative rotation of the cap with respect to the profiled section around the elementary articulation.

For example, the first locking means includes a latch mounted so as to rotate around an axis perpendicular to the bottom, and the second locking means includes a slot made in the border of the lower flap and selectively keeps the latch trapped.

Housings can be made in the thickness of the small bar for receiving consumable samples, the openings made in the display surface of the cap then preferably being arranged and sized in order to prevent extraction of the samples from the small bar from the exterior of the cap.

At least a first of the housings of the small bar is advantageously formed by a bore bordered by a shoulder and passing through the small bar right through its thickness, and the bottom of the profiled section can have, at least facing the shouldered bore, a hole making it possible, after at least partial raising of the cap with respect to the profiled section, to withdraw the sample arranged in the first housing by application of pressure exerted on the sample through the hole and the shouldered bore.

In the case in which the frame has braces roughly transverse with respect to the first direction, the upper flap of the cap preferably has cut-outs due to which it straddles the braces, this arrangement making it possible to increase the rigidity of the frame, and particularly to oppose deformation of its corners.

As a variant, the frame can have two ledges shaped as angle steels and elongated according to a second direction in order to form two end edges of the frame, each ledge having a first sheet extending in a plane parallel to the first and second directions and a second sheet extending in a plane perpendicular to the first direction, and each ledge can have first and second angle brackets arranged in two adjacent corners of the frame and each extending in a plane parallel to the first sheet.

In order to increase the rigidity of the frame, these angle brackets can, for example, extend in two different respective planes, both parallel to the first sheet.

Furthermore, each ledge has, for example, a third sheet perpendicular to the first and second sheets and defining a back support surface surmounted by a hook. This support surface can possibly be run through by a screw for adjustment of the inclination of the ledge on a carrier structure.

The second sheet advantageously has a notch suitable for cooperating with the cap in order to complete the holding of this cap.

The device according to the invention can also include a magnet integrated in the shoulder of the shouldered bore and suitable for holding in place the sample arranged in the first housing.

Non-planar spring blades can be inserted between the bottom of the profiled section and the small bar in order to elastically push this small bar towards the display surface of the cap.

The small bar can have a fool-proofing device, in particular if it carries samples of different types.

The cap and/or the profiled section are, for example, formed by a cut and folded metal sheet.

Likewise, each ledge can be formed by a metal sheet cut and folded in order to fit into a trihedron.

In a possible embodiment of the invention, the small. bar is, for example, produced from sawdust immersed in a glue under pressure, or plexiglass.

Other characteristics and advantages of the invention will emerge clearly from the description given for it hereafter in an indicative and in no way limiting basis, in reference to the appended drawings in which:

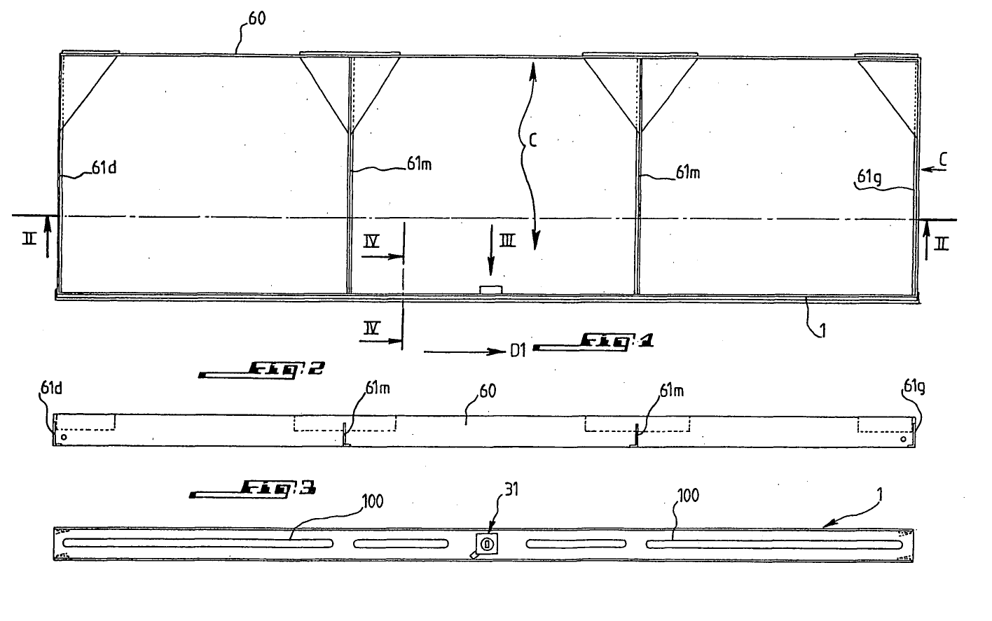

FIG. 1 is a top view of a frame in a first embodiment of the invention;

FIG. 2 is a cutaway view of the frame of FIG. 1, the cut being made according to the angle of incidence defined by lines II-II of this FIG. 1;

FIG. 3 is a back view of the front edge of the frame of FIG. 1, observed according to the angle of incidence defined by arrow III of FIG. 1;

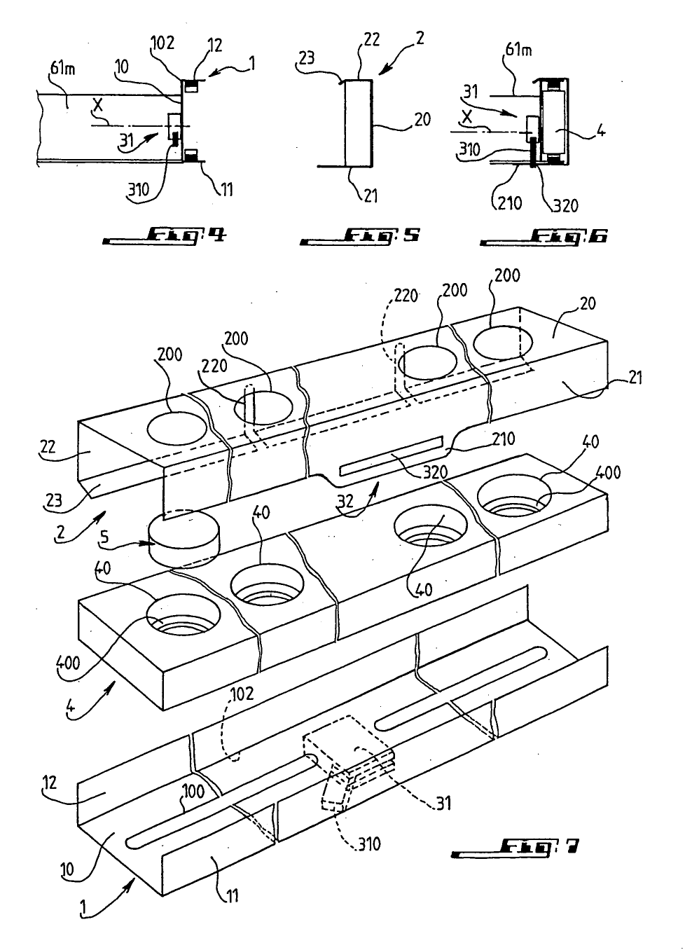

FIG. 4 is a partial cutaway view of the frame of FIG. 1, made according to the angle of incidence defined by lines IV-IV of FIG. 1;

FIG. 5 is a cutaway view of the cap;

FIG. 6 is a partial cutaway view of the frame of FIG. 1 similar to FIG. 4 but also illustrating the small bar and the cap positioned and locked on the profiled section;

FIG. 7 is an exploded perspective view of the profiled section, the small bar and the cap;

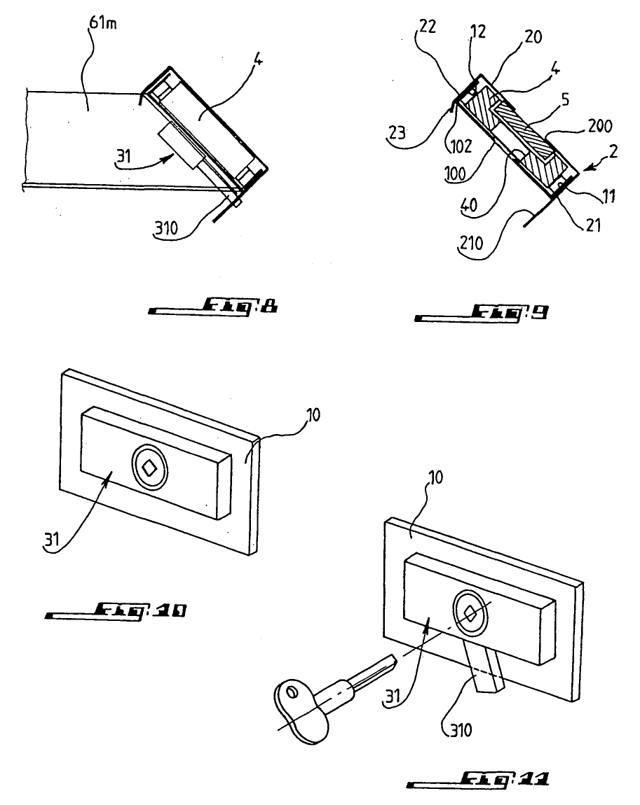

FIG. 8 is a view similar to FIG. 6, representing a variant belonging to the first embodiment of the device of the invention;

FIG. 9 is a view similar to FIG. 8, the cut being made through a consumable sample;

FIG. 10 is a perspective view of the latch represented in unlocked position;

FIG. 11 is a perspective view of the latch represented in locked position;

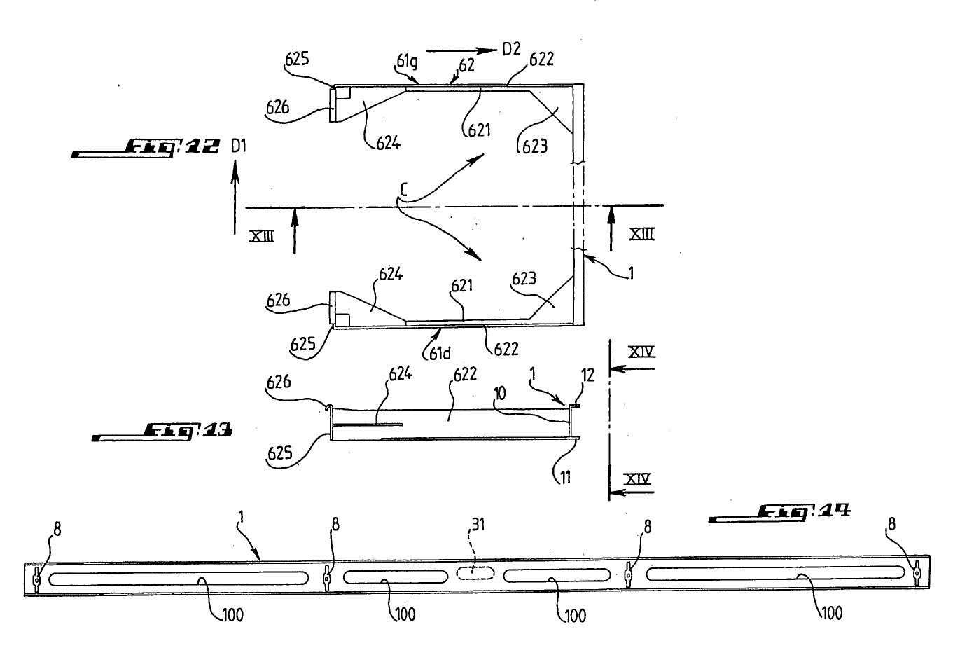

FIG. 12 is a top view of a frame in a second embodiment of the invention;

FIG. 13 is a partial cutaway view of the frame of FIG. 12, made according to the angle of incidence defined by lines XIII-XIII of FIG. 12;

FIG. 14 is a front view of the profiled section which can be seen in FIG. 13, observed according to the angle of incidence defined by lines XIV-XIV of FIG. 13;

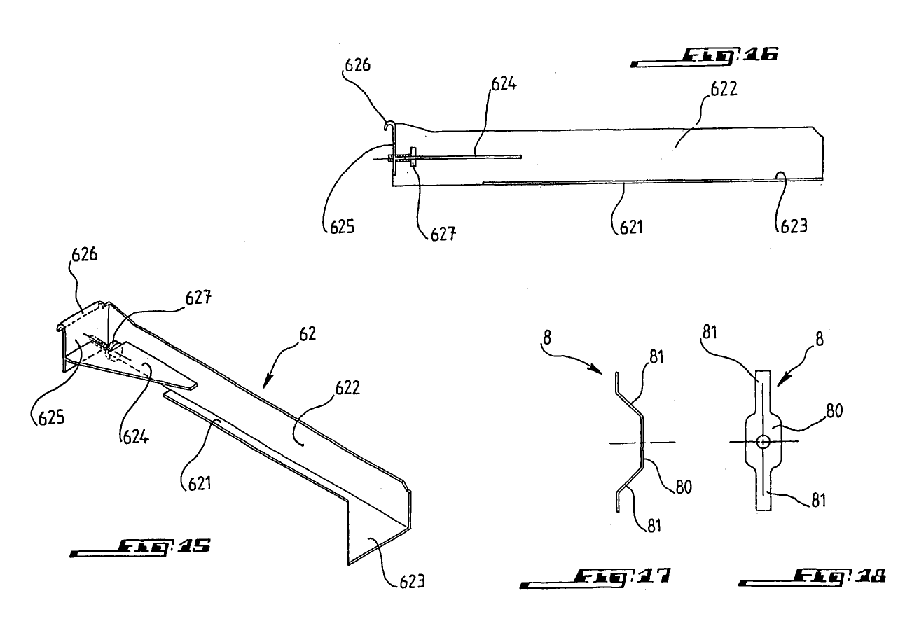

FIG. 15 is a perspective view of a ledge used in the frame illustrated in FIG. 12;

FIG. 16 is a side view of the ledge illustrated in FIG. 15;

FIG. 17 is a side view of a spring blade mounted on the profiled section illustrated in FIG. 14;

FIG. 18 is a top view of the spring blade illustrated in FIG. 17;

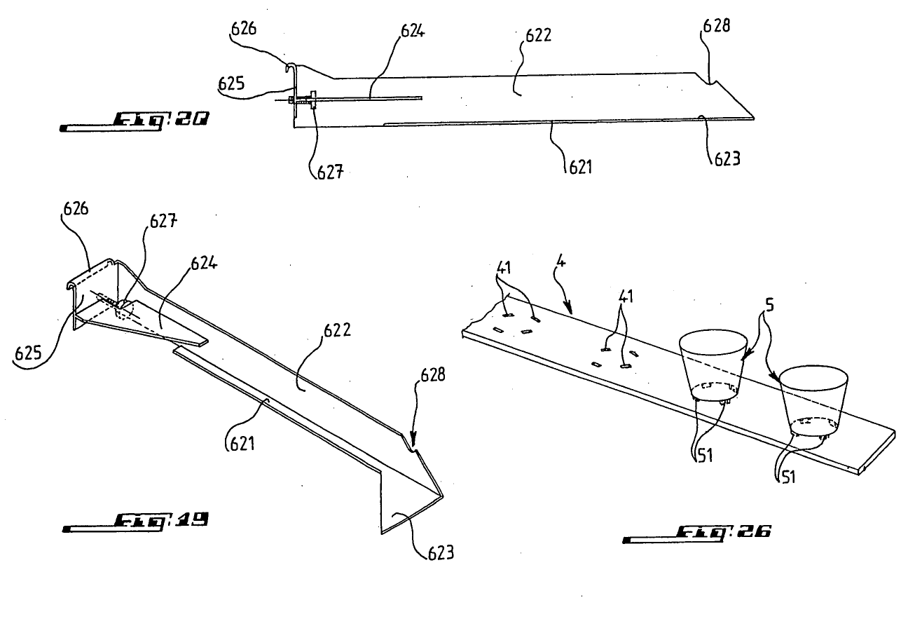

FIG. 19 is a perspective view of a ledge corresponding to a variant of the ledge illustrated in FIG. 15;

FIG. 20 is a side view of the ledge illustrated in FIG. 19;

FIG. 21 is a front view of a small bar which is intended to receive samples;

FIG. 22 is a partial enlarged front view of the small bar illustrated in FIG. 21;

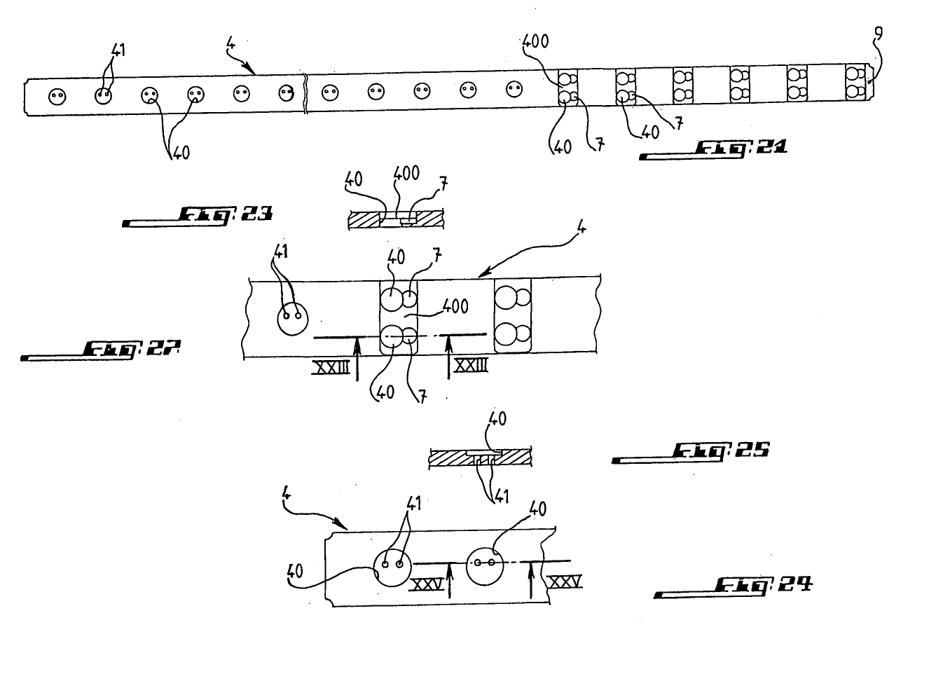

FIG. 23 is a cutaway view of the small bar illustrated in FIG. 22, observed according to the angle of incidence defined by arrows XXIII-XXIII of this FIG. 22;

FIG. 24 is another partial enlarged front view of the small bar illustrated in FIG. 21;

FIG. 25 is a cutaway view of the small bar illustrated in FIG. 24, observed according to the angle of incidence defined by arrows XXV-XXV of this FIG. 24; and

FIG. 26 is a partial perspective view of another type of small bar, represented with a sample.

As stated in the preceding, the invention relates to a device for display of samples, which can be used particularly for display of samples of cosmetic products, in the immediate proximity of the latter. This device includes frame C, rectangular, for example, (FIGS. 1 and 12), which is at least formed by front edge 1 which receives the samples and which extends longitudinally according to direction D1, and by two end edges 61g and 61d adjacent to front edge 1.

This frame can be completed (FIG. 1) by back edge 60 parallel to the front edge and belonging to a carrier structure (not represented), and possibly by transverse braces 61m.

According to the invention, the front edge of this frame C is formed by profiled section 1 which in cross section (FIGS. 4 and 13) has bottom 10 bordered by lower fold 11 and by upper fold 12, these two folds projecting from bottom 10 perpendicularly to this bottom 10.

The device of the invention furthermore has removable cap 2, seen in cross section in FIGS. 5, 6, 8 and 9, which forms a cover for profiled section 1, and which extends over the whole length of the latter.

Cap 2 has, in cross section, display surface 20 bordered by lower flap 21 and by upper flap 22, these two flaps projecting from display surface 20 perpendicularly to this surface and in the direction of bottom 10 of profiled section 1.

As shown in FIGS. 6, 8 and 9, upper flap 22 overlaps upper fold 12 and goes beyond it by means of secondary flap 23 which slopes towards bottom 10 in such a way as to form an elementary articulation of cap 2 on profiled section 1, and more precisely on edge 102 of the profiled section, which is common to upper fold 12 and to bottom 10 of this profiled section.

Bottom 10 of the profiled section bears locking mechanism 31, which includes, for example, (FIGS. 10 and 11), latch 310 mounted so as to rotate around axis X perpendicular to this bottom 10.

Lower flap 21 of cap 2 overlaps lower fold 11 (FIGS. 6 and 9) and goes beyond it by means of border 210 which may equally extend all along cap 2 or only locally as shown in FIG. 7.

Border 210 has locking component 32 which cooperates with locking mechanism 31 of profiled section 1, and which, for example, takes the form of slot 320 made in border 210 and which is capable of trapping latch 310 as desired, and is consequently capable of allowing or preventing a relative rotation of cap 2 with respect to profiled section 1 around the elementary articulation formed on edge 102.

As shown particularly in FIGS. 7, 9 and 21 to 26, the device of the invention includes small bar 4 which is perforated with housings 40 which are intended to receive samples 5, such as samples of colors and/or consumable samples.

This small bar can, for example, be produced out of a material commonly called “Medium” commercially, that is to say out of a material consisting of sawdust immersed in a glue under pressure, or, lacking that, out of plexiglass.

Small bar 4 thus constituted is inserted between bottom 10 of profiled section 1 and display surface 20 of cap 2.

In order to ensure satisfactory maintaining of small bar 4, non-planar spring blades 8 (FIGS. 14, 17 and 18) can be inserted between bottom 10 of profiled section I and small bar 4, these spring blades having base 80, for example, riveted on profiled section 1, and two curved lateral wings 81, elastically pushing small bar 4 towards display surface 20 of cap 2.

Lacking this, a layer of foam can be used instead of these spring blades.

In the case in which small bar 4 carries samples 5 of different types, for example, consumable and non-consumable samples, or samples of different forms and/or nature, it preferably has a fool-proofing mark such as perforation 9 (FIG. 21).

Display surface 20 of cap 2 is perforated with openings 200 which give access to samples 5 from the exterior of this cap 2.

As shown in FIGS. 7 and 9, openings 200 of surface 20 are arranged and sized in order to eliminate any possibility of extracting samples 5 from small bar 4 from the exterior of cap 2.

At least some housings 40 of small bar 4, or at least one of them, is/are formed by a bore which passes through small bar 4 right through its thickness, and which is bordered by shoulder 400.

Furthermore, bottom 10 of profiled section 1 has, facing this shouldered bore 40 or facing all of these bores, hole 100 which passes through it.

After rotation of cap 2 with respect to profiled section 1 around edge 102, and possibly after removal of this cap, it is thus possible to withdraw sample 5 arranged in housing 40 by applying pressure on this sample 5 through hole 100 and shouldered bore 40; each consumable sample can thus be easily replaced.

In order to complete the maintaining of sample 5 arranged in shouldered housing 40, the device of the invention includes, for example, (FIGS. 22 and 23), magnet 7 integrated in shoulder 400 of this bore and which exerts a force of attraction on the metallic cup which forms the package for this sample.

As shown in FIGS. 21, 22 and 24 to 26, small bar 4 can also have impressions 41 in which tabs 51 (FIG. 26) borne by samples 5 can be engaged.

As shown particularly in FIG. 7, cap 2 and profiled section 1 can each advantageously be formed by a cut and folded metal sheet.

In the case, which corresponds to the embodiment illustrated in FIG. 1, in which frame C has braces 61m which are transverse with respect to profiled section 1, upper flap 22 of cap 2 preferably has cut-outs 220, due to which it straddles braces 61m.

Cap 2 thus functions as angle bracket for the braces and contributes to the rigidity of frame C by preventing the frame from being deformed into a non-rectangular parallelogram.

Furthermore, as shown in FIGS. 8 and 9, bottom 10 of profiled section 1 and surface 20 of cap 2 which are parallel to one another can be inclined with respect to the plane of frame C, as a function of the distance separating this frame from the ground surface, so as to allow easier examination of the samples for a person in vertical position, in the case in which the frame extends in a horizontal plane.

In the preferred embodiment illustrated in FIGS. 12 to 25, the two end edges 61d and 61g of frame C consist of two ledges 62 shaped as angle steels and elongated according to a direction D2 perpendicular to first direction D1.

Each ledge 62 has first sheet 621 which extends in a plane parallel to directions D1 and D2, second sheet 622 which extends in a plane perpendicular to direction D1, and third sheet 625 which is perpendicular to first and second sheets 621 and 622.

Each ledge 62, which therefore fits in a trihedron, can be formed by a cut and folded metal sheet.

On the other hand, each ledge 62 advantageously has first and second angle brackets 623 and 624 which are arranged in two adjacent angles or corners of frame C and which extend, parallel to first sheet 621, in two different respective planes, these angle brackets ensuring the rigidity of frame C in its plane by preventing deformation of its corners.

Third sheet 625 of each ledge (FIGS. 15 and 19) defines a back support surface of this ledge, which is surmounted by hook 626 and which is run through by screw 627 for adjustment of the inclination of this ledge 62 on a carrier structure (not represented).

Finally, as shown in FIG. 19, second sheet 622 can have a notch such as 628, which is suitable for cooperating with cap 2 in order to complete the holding of this cap 2.

1. A device for display of samples, particularly for cosmetic products, which has frame (C) whose front edge receives the samples, characterized by the fact that the front edge of (C) frame is formed by profiled section (1) elongated according to first direction (D1) and having bottom (10) bordered by lower (11) and upper (12) folds both projecting, in cross section, from bottom (10), by the fact that this device has removable cap (2) elongated according to first direction (D1), forming a cover for profiled section (1), and having display surface (20) bordered by lower (21) and upper (22) flaps both projecting, in cross section, from display surface (20) in the direction of bottom (10) of profiled section (1) and respectively overlapping lower (11) and upper (12) folds, by the fact that upper flap (22) goes beyond upper fold (12) sloping towards bottom (10) in order to form an elementary articulation of cap (2) on edge (102) common to upper fold (12) and to bottom (10) of profiled section (1), and by the fact that samples (5) are received in small bar (4) inserted between bottom (10) of profiled section (1) and display surface (20) of cap (2), these samples (5) being made accessible, from the exterior of cap (2), through openings (200) made in display surface (20) of this cap (2).

2. A device for display of samples according to claim 1, characterized by the fact that bottom (10) bears some first locking means (31), by the fact that lower flap (21) has border (210) which goes beyond lower fold (11), and by the fact that border (210) of lower flap (21) has some second locking means (32) which cooperates with first locking means (31) in order to selectively allow or prevent a relative rotation of cap (2) with respect to profiled section (1) around the elementary articulation.

3. A device for display of samples according to claim 2, characterized by the fact that first locking means (31) includes latch (310) mounted so as to rotate around axis (X) perpendicular to bottom (10), and by the fact that second locking means (32) includes slot (320) made in border (210) of lower flap (21) and selectively keeps latch (310) trapped.

4. A device for display of samples according to any one of the preceding claims, characterized by the fact that housings (40) are made in the thickness of small bar (4) for receiving consumable samples (5), and by the fact that openings (200) made in display surface (20) of cap (2) are arranged and sized in order to prevent extraction of samples (5) from small bar (4) from the exterior of cap (2).

5. A device for display of samples according to claim 4, characterized by the fact that at least a first of housings (40) of the small bar is formed by a bore bordered by shoulder (400) and passing through small bar (4) right through its thickness, and by the fact that bottom (10) of the profiled section has, at least facing shouldered bore (40), hole (100) making it possible, after at least partial raising of cap (2) with respect to profiled section (1), to withdraw sample (5) arranged in first housing (40) by application of pressure exerted on sample (5) through hole (100) and shouldered bore (40).

6. A device for display of samples according to any one of the preceding claims, characterized by the fact that frame (C) has braces (61m) roughly transverse with respect to first direction (D1), and by the fact that upper flap (22) of cap (2) has cut-outs (220) due to which it straddles braces (61m).

7. A device for display of samples according to any one of claims 1 to 5, characterized by the fact that the frame has two ledges (62) shaped as angle steels and elongated according to second direction (D2) in order to form two end edges (61d, 61g) of frame (C), by the fact that each ledge (62) has first sheet (621) extending in a plane parallel to first and second directions (D1, D2) and second sheet (622) extending in a plane perpendicular to first direction (D1), and by the fact that each ledge (62) has first and second angle brackets (623, 624) arranged in two adjacent corners of frame (C) and each extending in a plane parallel to first sheet (621).

8. A device for display of samples according to claim 7, characterized by the fact that first and second angle brackets (623, 624) extend in two different respective planes.

9. A device for display of samples according to claim 7 or 8, characterized by the fact that each ledge has third sheet (625) perpendicular to first and second sheets (621, 622) and defining a back support surface surmounted by hook (626).

10. A device for display of samples according to any one of claims 1 to 5, combined with any one of claims 7 to 9, characterized by the fact that second sheet (622) has notch (628) suitable for cooperating with cap (2) in order to complete the holding of this cap (2).

11. A device for display of samples according to any one of the preceding claims, combined with claim 5, characterized by the fact that it has magnet (7) integrated in shoulder (400) of shouldered bore (40) and suitable for holding in place sample (5) arranged in first housing (40) in place.

12. A device for display of samples according to any one of the preceding claims, characterized by the fact that non-planar spring blades (8) are inserted between bottom (10) of profiled section (1) and small bar (4) in order to elastically push this small bar (4) towards display surface (20) of cap (2).

13. A device for display of samples according to any one of the preceding claims, characterized by the fact that small bar (4) carries samples (5) of different types and has fool-proofing device (9).

14. A device for display of samples according to any one of the preceding claims, characterized by the fact that cap (2) and/or profiled section (1) are formed by a cut and folded metal sheet.

15. A device for display of samples according to any one of claims 1 to 5, combined with any one of claims 7 to 10, characterized by the fact that each ledge (62) is formed by a metal sheet cut and folded in order to fit into a trihedron.

16. A device for display of samples according to any one of the preceding claims, characterized by the fact that small bar (4) is produced from sawdust immersed in a glue under pressure, or out of plexiglass.
